(19) United States
(12) Patent Application Publication
(10) Pub. No.: US 2007/0254546 A1
(43) Pub. Date: Nov. 1, 2007

(54) NONWOVEN TEXTILE ASSEMBLY, METHOD OF MANUFACTURE, AND SPIRALLY WOUND PRESS FELT COMPRISED OF SAME

(75) Inventor: Marc P. Despault, Ottawa (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: ASTENJOHNSON, INC., Charleston, SC (US)

(21) Appl. No.: 11/740,343

(22) Filed: Apr. 26, 2007

(30) Foreign Application Priority Data
Apr. 26, 2006 (GB) 0608280.4

(51) Int. Cl. D04H 1/00; B31B 1/60; D04H 3/05; B32B 5/26; D04H 1/46; D04H 1/54; B32B 29/02

(52) U.S. Cl. 442/366; 442/381; 442/383; 442/402; 442/412; 442/409; 442/50; 156/60

(57) ABSTRACT

A nonwoven textile assembly, a method for its manufacture, and a spirally wound press felt made from the assembly are disclosed. The nonwoven textile assembly is manufactured by providing a uniform array of parallel yarns having constant height and spacing as a first textile component and which are oriented in a first direction. An adhesive material is applied to a first side of the first component. A second textile component, such as a second array of parallel yarns oriented at an angle of from 2° to 90° to the first, or a nonwoven mesh, or a nonwoven scrim comprising a regenerated cellulosic is then laid over the adhesive material. A lightweight batt layer optionally including a second adhesive preferably located on the side of the batt facing the second side of the second textile component, is overlaid the second textile component. The assembled first textile component, adhesive component (if applicable), second textile component, adhesive component (if applicable) and batt, is then passed through a pressure zone which is preferably heated so as to activate the adhesives and securely hold the first and second textile components in place along with the batt material. Optionally, the batt material may contain bi-component fibers of which one of the two components is a heat activated adhesive. The resulting nonwoven textile assembly may then be needled in a needling unit downstream of the heated nip, or otherwise processed. A spirally wound press felt comprised of at least one helically wound, abutting strip of the nonwoven textile assembly is provided.

### FIELD OF THE INVENTION

The present invention is directed towards industrial textiles for papermaking and similar continuous process applications. The invention specifically concerns nonwoven textile assemblies suitable for use in the construction of spirally wound press felts for use in a papermaking or similar process, methods for their construction, and press felts comprised of the assemblies.

### BACKGROUND OF THE INVENTION

Conventional press felts are formed by weaving a base fabric and then needling into it a batt of fine, nonwoven fibrous material. The base fabrics are almost always woven structures comprised of monofilament, plied monofilament, or multifilament yarns, and may be of single layer, multilayer or laminate construction. The component yarns are typically extruded from polymeric resins such as polyamides or polyesters. The base fabric is designed to provide a void volume to hold the water expressed from the sheet during pressing, be resilient, resist compaction and, in particular, provide for uniform pressure distribution under compressive loading so as to prevent undesirable sheet marking.

The woven base fabric may take any one of several forms. It may be endless woven in the manner of a tube or sock, or flat woven and subsequently rendered endless by the formation of a seam, or it may be produced by a modified endless weaving process in which the lateral edges are provided with seaming loops which are subsequently interdigitated upon installation.

It is known from U.S. Pat. No. 5,268,076 and U.S. Pat. No. 5,360,656 to assemble base fabrics for press felts by spirally winding at least one layer of a relatively narrow woven fabric strip, whose width is much less than that of the completed fabric, so as to build up a fabric of the desired width and length. Adjacent turns of the narrow woven fabric strip are abutted against one another and the resulting helically continuous seam is joined by sewing, stitching, welding, etc. Once the desired full fabric width is obtained by spirally winding the at least one strip, the assembled base fabric is removed from the frame upon which it has been assembled and is then needled. Numerous variants to the process are known.

For example, WO 04/072364 discloses a spirally wound industrial process fabric in which successive turns of the spirally wound material strip are bonded to one another by one of various means.

WO 05/056920 discloses a method for forming a textile structure by spirally winding an array of parallel machine direction (MD) yarns and then depositing a pattern of cross machine direction (CD) elements onto the system.

U.S. Pat. No. 6,752,890 claims a method of making a press fabric by spirally winding and attaching a top laminate layer to a base fabric by various means.

U.S. Pat. No. 6,565,713 discloses a method of making a spirally wound press felt in which a laminated strip structure is pre-manufactured and then spirally wound to the desired full length and width.

U.S. Pat. No. 6,283,165 discloses a method of constructing a spirally wound press felt wherein an array of CD oriented yarns is laid over and sandwiched between an array of MD oriented yarns which have been spiraled around the CD yarns; the opposing MD folded ends are subsequently used to form seaming loops.

U.S. Pat. No. 4,781,967 discloses a nonwoven press felt comprising a plurality of unwoven yarn assemblies overlying one another in nonparallel orientation, each of which includes a yarn array and at least one layer of batt that are united without a separate yarn binding means.

U.S. Pat. No. 4,495,680 discloses a method and apparatus for making a papermaking fabric in which an array of MD yarns is drawn from a supply and helically wound on a pair of parallel drive rolls; a layer of batt is then attached to the yarn array to stabilize it.

U.S. Pat. No. 3,097,413 discloses a press felt having a nonwoven porous structure made of a yarn layer comprised of helically arranged continuous yarn lengths; the yarns have a composite structure.

EP 38276 discloses a nonwoven press felt comprising one or more layers of batt material needled to central arrays of MD and CD oriented yarns.

To be effective, a press felt must provide uniform support for the paper web as the felt and web pass together through at least one nip. It is particularly important that the base fabric of the press felt impart a minimum of mark to the web. It is also important that the base fabric provide a degree of void volume that is appropriate for the intended use of the press felt. Ideally this void volume should not change over time due to the cyclic compressive load imparted by the presses. In addition, the base fabric should provide the press felt with a high degree of strength and stability so that it may resist out of plane distortions and maximize fabric life.

A problem common to all of the aforementioned prior art fabric constructions, especially those including one or more arrays of nonwoven parallel yarns as base fabric components, concerns the uniformity of support provided to the web by the base fabric. In particular, it has been found that both the CD and vertical (Z-direction) spacing of the nonwoven parallel yarns of the arrays are difficult to control during manufacture and frequently will vary. Irregularities in the yarn spacing negatively impact the pressure uniformity of the fabric, and thus its performance. It is well known that non-uniformities in the base fabric will cause irregular drainage of the web in the nip and thus impart an undesirable pattern to the paper web as it is dewatered. These non-uniformities also occur in press felts assembled by the spiral winding method because it is necessary to join the relatively narrow component fabric strips to one another along their longitudinal edges by means such as sewing, ultrasonic bonding and the like. The non-uniformities create a discontinuity in the base fabric which evidences itself in the paper web following pressing. This is referred to as “shadow marking” and press felt manufacturers continually strive to ensure that such marking is minimized to the greatest degree possible.

Non-uniform spacing and positioning of the component yarns in spirally wound yarn arrays appear to be due in part to the mechanism used to guide the yarns into a parallel and planar orientation prior to their consolidation into the base fabric, such as by needling, laminating or other bonding means. Prior to the present invention, yarn guiding was typically accomplished by passing the yarns under tension through a reed or similar comb type of spacing means such as is known in the art. However, the yarns are almost never delivered at a uniform CD spacing to the assembly nip following passage through the reed, and gaps in the yarn spacing, caused by the presence of the reed dent, are frequently visible in the final product. Further, when a high yarn fill is desired in the assembled fabric i.e. when the number of yarns per unit width is close to the maximum number that that space can dimensionally accommodate, the yarns will tend to “wander” somewhat or “bunch up” prior to or following the reed and become vertically displaced out of the plane. The reed alone cannot guide and distribute the yarns so that they are regularly spaced in the CD as they are delivered for assembly. Thus a press felt including a high yarn fill yarn array that is delivered for assembly through a reed type apparatus will frequently provide some irregular drainage patterns which may produce an undesirable level of shadow marking in the sheet.

A further problem that is common to all press felts, regardless of whether they include a woven base fabric or one that is spirally wound, concerns what is commonly referred to as their “break-in” period and subsequent performance over the life of the felt. Typically it will take about 2-3 days for a press felt to attain a steady state operating condition because of the time required for the felt to reach a maximum level of compaction and moisture saturation. Generally, this capability will be maintained for anywhere from about 4-6 weeks after which dewatering and other physical performance characteristics such as resiliency begin to decline as the fabric construction fills up with contaminants or breaks down and loses void volume due to the repetitive cyclic compression to which it is exposed. The fabric must be replaced when vibration or its dewatering performance reach a point where it is no longer economical for the mill to continue to run the fabric.

It is known that certain fabric constructions, such as those sold under the designation AtroCross® and which are available from Heimbach GmbH & Co. of Düren, Germany, appear to break in quickly and maintain both their resiliency and dewatering performance longer than other constructions. This appears to be due to the use of arrays of MD and CD oriented yarns in the base fabric construction. These fabrics are constructed more or less as disclosed in U.S. Pat. No. 4,781,967 to Draper et al. which teaches the construction of a press felt from a plurality of unwoven yarn assemblies each including at least one layer of batt for support and each assembly oriented transversely (or non-parallel) to the adjacent assembly. This construction has proven to be very suitable in providing a resilient base fabric which maintains its void volume and provides excellent dewatering performance for longer periods than fabrics of differing construction. However, prior to the present invention, it has not been possible to provide a spirally wound press felt base fabric with performance characteristics similar to those obtained from the AtroCross® fabric and which does not impart shadow marks to the web.

None of the prior art teaches a means of providing a spirally assembled nonwoven textile assembly including at least one array of parallel yarns wherein the yarn spacing in the array is uniform, the vertical displacement of the yarns is constant, and the yarns are arranged at a high fill so as to provide a dimensionally stable, non-marking base fabric with constant void volume for use in a press felt which is comprised of the nonwoven textile assemblies. The present invention provides a simple and elegant solution to this problem.

### SUMMARY

The present invention concerns a nonwoven textile assembly for use in the construction of a spirally wound press felt base fabric, a method for its manufacture, and a spirally wound press felt comprised of same. The nonwoven textile assemblies of the invention are comprised of at least first and second nonwoven fabric components, at least one layer of batt, and an adhesive material. The first nonwoven fabric component is comprised of an essentially planar nonwoven array of parallel yarns having a yarn fill of from 60% to 105% wherein the yarn-to-yarn spacing of the component yarns in the array varies on average by less than 75% of one yarn diameter within the plane of the array, and preferably also in a Z or vertical direction out of the plane of the array. More preferably, the yarn-to-yarn spacing varies by less than about 50% of one yarn diameter in the plane of the array as well as in the Z or vertical direction out of the plane of the array. Most preferably, the yarn-to-yarn spacing varies by less than about 25% of one yarn diameter in the plane of the array as well as in the Z or vertical direction out of the plane of the array. The second nonwoven fabric component will include one or more of the following: an extruded mesh or similar nonwoven; a second nonwoven parallel yarn array; one or more layers of a nonwoven batt material; and/or a fabric scrim or web. If the second fabric component is a second array of parallel yarns, then those yarns are delivered to the nonwoven textile assembly so as to be oriented at some angle to the yarns in the first nonwoven array of parallel yarns, preferably from at least 2° up to about 90° to the yarns in the first array. When the second nonwoven fabric component is comprised of an essentially planar nonwoven array of parallel yarns, the component yarns will have a yarn fill of from 60% to 105% and the yarn-to-yarn spacing of the component yarns in the array varies on average by less than 75% of one yarn diameter within the plane of array, and preferably also in a Z or vertical direction out of the plane of the array. Preferably, the yarn fill of the second nonwoven fabric component is approximately equal to that in the first component. Preferably, the yarns in the first nonwoven fabric component (the nonwoven array of parallel yarns) are oriented in the MD and are proximate (closest to) the PS of the fabric. The at least one layer of batt can comprise staple fibers that can be randomly oriented or preferentially oriented in one direction, and which may include or be placed over or coated with adhesive material. The first and second nonwoven components are joined together by means of the adhesive material. The adhesive material is either heat or pressure activated. Preferably, the adhesive material is heat activated.

A critical feature of the invention is the uniformly planar positioning and regular horizontal spacing of the yarns comprising the nonwoven parallel yarn array components. Prior to this invention, it has not been possible to reliably deliver for assembly into a spirally wound press felt a planar array of parallel yarns having a uniform yarn spacing at a high yarn fill of about 100%. In particular, the average yarn-to-yarn spacing in the prior art arrays could vary by more than 1-2 yarn diameters, which would create non-uniform pressure distribution under compressive loading, thus resulting in shadowing marking of the paper web. Due to the regular and uniform spacing of the yarns provided to the yarn arrays in accordance with the invention, which is on average less than 75% of one yarn diameter, the fabrics of the present invention impart little if any marking to the sheet. Additionally, the fabrics are highly stable and resist compressive loading so as to maintain void volume. An unexpected benefit derived from this construction is that shadow marking caused by irregularities at the edge-to-edge bonding of adjacent spirally wound strips, is significantly reduced or eliminated altogether due to the uniform and controlled spacing in the yarn array and the use of adhesive systems to bond the nonwoven components along their longitudinal edges, as will be explained more fully below.

The at least first and second nonwoven fabric components are assembled so as to be in a stacked arrangement and are then passed through a pressure zone, which is preferably an extended nip formed between two opposed belts. Either the belts or the extended nip may be heated so as to trigger the heat activated adhesives to securely hold the fabric components in place along with the batt material. Alternatively, the nip is formed between two pressure rolls which may be heated. However, this latter arrangement is not generally preferred as the pressure developed in the relatively shorter nip may in certain circumstances (such as when the yarn fill of the nonwoven array of parallel yarns is above 90%) cause lateral displacement of the individual yarns in the array. Optionally, the batt material may contain bi-component fibers of which one of the two components is a heat activated adhesive. The resulting nonwoven textile assembly may then be needled in a needling unit downstream of the nip, or otherwise processed.

A spirally wound press felt comprised of at least one helically wound, abutting strip of the nonwoven textile assembly is also provided.

The essentially planar and uniform nonwoven array of parallel yarns is an important feature of the press felts of this invention and is obtained by passing the yarns, which are preferably plied monofilament yarns, through alternating vertically stacked guide channels in a yarn guide box just prior to the nip. The guide channels of the guide box are positioned in an alternating over and under arrangement with adjustable small or zero lateral gaps in the CD to ensure the uniformly planar and regular, parallel positioning of the individual yarns in the nonwoven array and subsequent fabric. When plied monofilament yarns are used as the yarn component of the nonwoven array of parallel yarns, the width dimension of the guide channels is in the range of from 10% to as much as 35% less than the sum of the diameters of the yarns passing through them. This causes the yarns to intermesh to the greatest degree possible inside the channels.

If the yarn array is comprised of solid polymeric monofilaments, then the width dimension of the guide channels may be equal to, or from about 1% to about 10% less than the total width or diameter of the monofilament yarns passing through them.

Preferably the yarns are delivered to the yarn guide box under a generally uniform tension which is preferably in the range of from about 2 pli (pounds per linear inch) to about 10 pli.

Preferably, the yarn guide box is located downstream of a reed or similar arrangement through which the yarns are threaded as they are drawn from a source of supply and upstream of the nip pressure zone in which fabric assembly occurs. It is recommended that lease rods be used to ensure a generally uniform tension of the yarns extending from the reed to the yarn guide box.

Optionally, the yarn guide box can be provided with a heat source so that the yarns are heated prior to their delivery to the nip.

When two or more nonwoven arrays of parallel yarns are to be provided in the nonwoven textile assembly, the component yarns of the arrays are preferably oriented at from at least 2° to about 90° with respect to each other. Preferably, the second array of yarns is delivered through a separate arrangement, which could be, for example, a second yarn guide box located upstream of the nip or an arrangement for guiding a preformed second array over the first array. Alternately, the second array of yarns is delivered by means of a yarn delivery arrangement such as disclosed in U.S. Pat. No. 7,056,403 (Colson et al.) and its continuations, all of which are incorporated herein by reference as if fully set forth. The second delivery arrangement will be oriented at an angle equal to the desired orientation of the yarns in the second yarn array, which will be from about 2° to about 90° to the direction of the first yarn guide box.

Preferably, the yarn fill of the nonwoven arrays of parallel yarns as provided in the nonwoven textile assembly is from about 60% to about 105%. More preferably, the yarn fill is from 90% to 105%. Most preferably, the yarn fill is 100%.

Preferably, the adhesive material is incorporated into one or both surfaces of the second nonwoven fabric component when it is provided as an extruded mesh. Alternatively, the adhesive material is a nonwoven adhesive web. As a further alternative, the adhesive material is provided as a coating on the yarns used to form the array. Preferably, the adhesive material is heated activated. Optionally, the adhesive is a pressure sensitive material which is applied as a spray, sheet or other web to one or more of the surfaces being bonded together.

As a further alternative, the batt material is comprised of a bi-component material including a first polymer and a heat activated adhesive material as a second component. Alternatively, one or both surfaces of the batt material are provided with a nonwoven adhesive scrim or an adhesive coating or spray.

Preferably, the nonwoven textile assembly is passed under pressure through an extended nip formed between two opposing moving belts such as would be provided in a belt laminator. More preferably, the extended nip is heated and is formed between two opposing heated belts. Most preferably, the heated extended nip is followed by a cooling zone. Alternatively, the heated nip is formed between two opposing heated rolls and is followed by a cooling zone. If a cooling zone is not provided, then the nip is preferably covered with a release paper or similar coating to prevent the assembly from sticking to one of the rolls following activation of the adhesives.

Alternatively, one or more of the fabric components is heated prior to joining it with the heat activated adhesive material. As a further alternative, the nip is heated prior to joining, and the fabric component is also heated so as to provide a more solid connection between the various layers.

### BRIEF DESCRIPTION OF THE DRAWINGS

The foregoing summary, as well as the following detailed description of the preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements shown. In the drawings:

FIG. 1 is an exploded assembly view of a nonwoven textile assembly in accordance with a first embodiment of the invention.

FIG. 2 is an exploded assembly view of a second nonwoven textile assembly in accordance with a second embodiment of the present invention.

FIG. 3 is a cross-sectional view of an assembled nonwoven textile assembly in accordance with either of FIGS. 1 or 2.

FIG. 4 is a cross-sectional view of an assembled nonwoven textile assembly in accordance with another embodiment of the invention with a batt on each surface of the textile assembly.

FIG. 5 is a cross-sectional view of an assembled nonwoven textile assembly connected to a woven base fabric in accordance with another embodiment of the invention, with a batt on each surface of the textile assembly.

FIG. 6 is a perspective view of equipment for forming the nonwoven textile assembly according to the invention including a reed, lease rods and yarn guide box for an array of parallel MD yarns.

FIG. 7 is a view of the yarn guide box taken along lines 7-7 in FIG. 6.

FIG. 8 is a perspective view similar to FIG. 6 showing equipment for forming the nonwoven textile assembly without the reed and with a needling device for needling the batt to the textile assembly.

FIG. 9 is a perspective view similar to FIG. 8 showing equipment for forming the nonwoven textile assembly utilizing a belt laminator for heating and adhering the layers of the nonwoven textile assembly together as well as to a woven base fabric, and with a needling device for needling the batt to the textile assembly.

FIG. 10A is a view showing the construction of a papermaking fabric utilizing the nonwoven textile assembly according to the invention by spiral winding.

FIG. 10B is an enlarged cross-sectional view showing the arrangement of two adjacent edges of the spirally wound nonwoven fabric strip used to make the spirally wound fabric according to the invention.

FIG. 11 is a view of the yarn guide in accordance with the invention.

FIG. 12 is a view representative of the non-uniform arrangement of plied monofilaments according to the prior art.

FIG. 13 is a view of the generally planar, regularly spaced plied monofilaments in accordance with the present invention.

FIG. 14 is a view showing the diameter of a plied monofilament.

FIG. 15 is a photograph of an array of plied monofilaments created according to the invention that are arranged for incorporation into a nonwoven fabric.

FIG. 16 shows a table of calculated maximum diameters of plied yarns useable in the nonwoven textile assembly according to the invention.

### DETAILED DESCRIPTION OF THE PREFERRED EMBODIMENTS

Certain terminology is used in the following description for convenience only and is not considered limiting. The words “lower” and “upper” designate directions in the drawings to which reference is made. “CD” refers generally to the cross-direction of a moving belt, for example in papermaking machines, and “MD” refers to the machine direction or direction of travel of a moving belt, such as a papermaking fabric in a papermaking machine. As used herein, the recitation of “at least one of A, B, and C” means A, B, or C or any combination thereof, where A, B and C are specifically referenced elements herein. Additionally, the terms “a” and “one” are defined as including one or more of the referenced item unless specifically noted. The term “yarn fill” refers to the amount of yarns in a given space, relative to the total space considered; a yarn fill of 100% means that the space available is completely filled with yarns (i.e., the yarns are edge-to-edge). It is possible to have yarn fill values greater than 100% in the fabrics of this invention, as will be discussed more fully below. The term “yarn diameter” or “yarn width” refers to the average diameter of plied monofilament yarn (for example, four-ply twisted monofilaments in a 2×2 twist), the diameter of a round monofilament, or the width dimension of a shaped monofilament, such as one having an oval or generally rectangular cross-sectional shape. The maximum diameter of a plied yarn (dₚ) can be determined as follows. If the maximum diameter of a single plied yarn (dₛ) containing nₛ monofilaments is

$${d}_{s} = \frac{{d}_{mono}}{sin ( π / {n}_{s} )} + {d}_{mono}$$

where
dₛ=maximum diameter of single plied yarn
dₘₒₙₒ=diameter of the monofilaments in the plied yarn (assumes all are the same size)
nₛ=number of monofilaments in the plied yarn.

Then the maximum diameter of a plied yarn (dₚ) containing two or more single plied yarns is:

$${d}_{p} = \frac{{d}_{s}}{sin ( π / {n}_{p} )} + {d}_{s}$$

where nₚb=no. of single plied yarns.
Substituting results in:

$${d}_{p} = \frac{\frac{{d}_{mono}}{sin ( π / {n}_{s} )} + {d}_{mono}}{sin ( π / {n}_{p} )} + \frac{{d}_{mono}}{sin ( π / {n}_{s} )} + {d}_{mono}$$

Table 1, shown in FIG. 16, provides the results of using this formula to determine the maximum theoretical envelope diameters of various plied yarns useable with the present invention. The table is not meant to be exhaustive, and other plied yarns not shown could also be utilized. From Table 1, it can be seen that the average diameter of the plied yarn (dₚ) containing two single plied yarns (ds) each having a diameter of 0.2 mm is 0.727 mm. Thus in a press felt made in accordance with the present invention and containing 0.2 mm yarns plied 2×2 (i.e., 0.2×2×2), the yarn to yarn spacing of the component yarns in the nonwoven array of parallel yarns varies on average by less than 0.55 mm (75%); more preferably this yarn spacing will vary by less than 0.36 mm (50%); and most preferably the yarn to yarn spacing will vary by less than 0.18 mm (25%). Applicant has noted that actual plied yarn diameters may vary from the theoretical calculated values due to variations in material stiffness, strength of twist, point of measurement, etc; and it is preferably the maximum of the theoretical or actual yarn diameter that should be used as the limitation for yarn to yarn spacing.

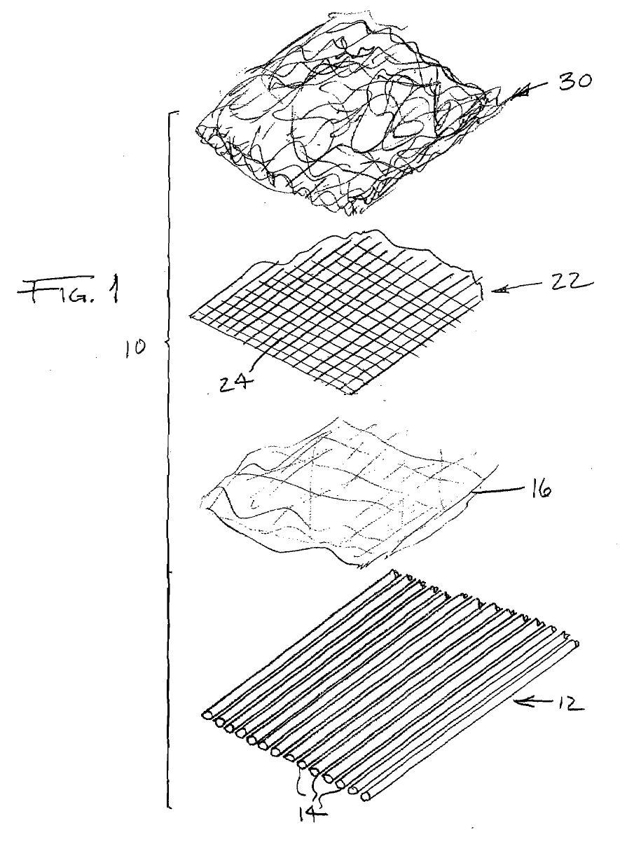

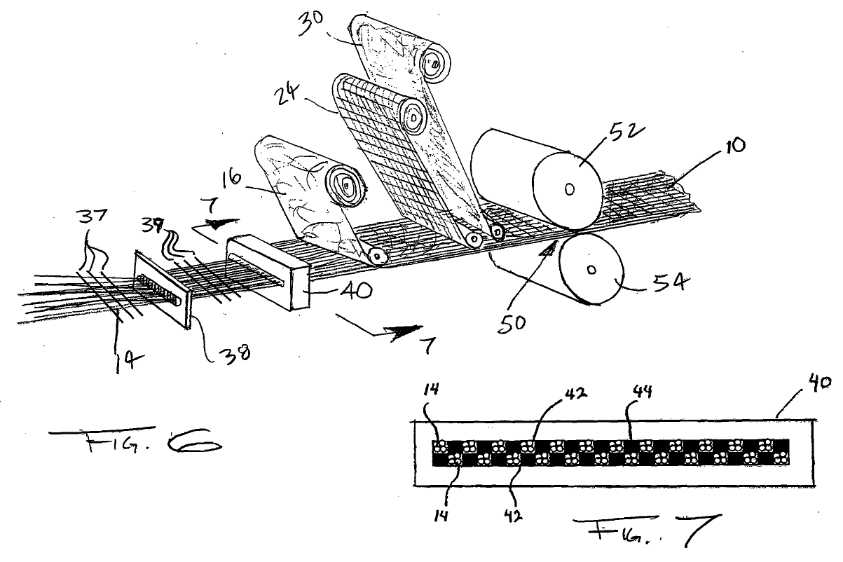

Referring to FIG. 1, a first nonwoven textile assembly 10 in accordance with the present invention is shown in an exploded view. The first nonwoven textile assembly 10 is comprised of an array of parallel yarns 12 which are preferably synthetic thermoplastic polymeric yarns 14 that are drawn under suitable tension from a series of yarn creels or other similar apparatus such as yarn canisters (not shown) and then through a reed 38 and lease rods 37 and 39 as shown in FIG. 6, so as to be generally uniformly tensioned and oriented generally parallel to one another.

The synthetic thermoplastic polymeric yarns 14 are preferably plied monofilament yarns, however, extruded monofilament or multifilament yarns may also be suitable in certain applications. In one preferred arrangement, four-ply twisted monofilaments with individual yarn diameters of 0.20 mm in a 2×2 twist (i.e. 0.20/2/2) have proven successful; however, other combinations may be suitable.

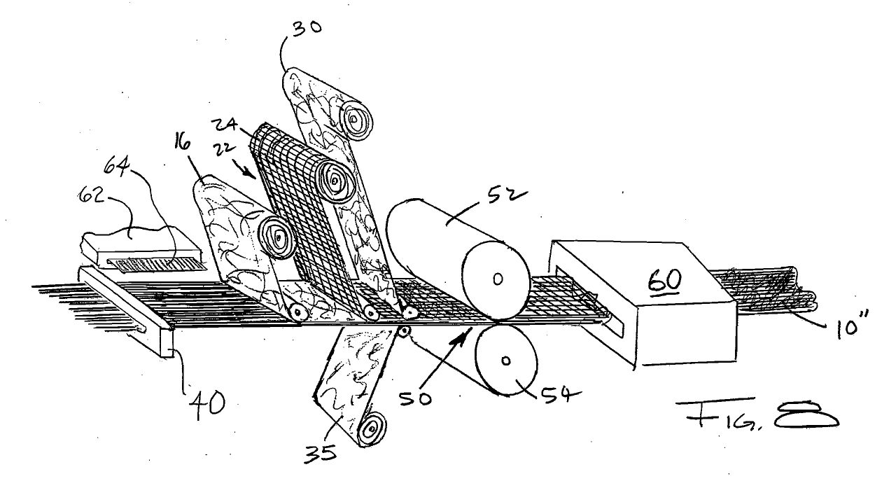

Following the reed 38, the yarns 14 may optionally be directed around two or more lease rods 39 to ensure uniform tension by evening out irregularities through friction and to facilitate repairs, when necessary. The yarns 14 then pass through an arrangement of guide channels in a yarn guide box 40 such as is shown in FIG. 7 to ensure that they are uniformly spaced and substantially planar when assembled, as will be described in more detail below. Alternatively, other types of monofilament, multi-filament or cabled monofilaments made from various other materials can be used depending on the intended use of the fabric; preferably the yarns 14 are plied monofilaments.

The array of yarns 12 may be heated in order for them to bond to a heat activated adhesive 16 to hold the yarns 14 together. This can be done by drawing the array of parallel yarns 12 through a heat source such as provided by the guide box 40 so as to raise their temperature sufficiently to activate the adhesive (depending on dwell time this is preferably in the vicinity of 320-360° F.), as shown in FIG. 6 and described in more detail below. If the textile assembly 10 is to pass through a heated nip, then this heating of the yarns 14 can be omitted.

As mentioned previously, it is critical that the placement of the yarns in the nonwoven array of parallel yarns be as uniform and planar as possible. In the fabrics of the present invention, the yarn-to-yarn spacing of the component yarns in the array varies on average by less than 75% of one yarn diameter within the fabric plane, and more preferably the variance in spacing is less than 50% of one yarn diameter. With uniform 100% fill, preferably the inter-plane yarn-to-yarn spacing varies by less than 25% of one yarn diameter. Additionally, the yarn-to-yarn spacing in a direction out of the plane of the array also varies by less than 75% of one yarn diameter. It has been found that such a regular planar spacing can be obtained by passing the yarns through the guide channels 42 of a yarn guide box 40 or similar structure, and by minimizing the distance between the yarn guide box and the nip.

A heat activated adhesive scrim 16 is preferably used as the adhesive, and may be, for example, a SpunFab® hot melt nylon adhesive web which is laid over a first surface of the parallel array of yarns. SpunFab® is available from Spunfab, Ltd., 175 Muffin Lane, Cuyahoga Falls, Ohio 44223. Another adhesive web that has been found to be particularly suitable in the practice of the invention is Bostik SPA112 available from Bostik Findley of 211 Boston Street, Middleton, Mass. 01949. Another adhesive material that has also been found to be suitable is Conwed adhesive netting # 810311-402 available from Conwed Plastics of 2810 Weeks Ave. SE, Minneapolis, Minn. 55414.

Alternatively, yarns coated with a heat-activated adhesive material, or those containing an adhesive that is incorporated directly into the yarns, may be utilized to form the array of parallel yarns 12. If such yarns are used, then it would not be necessary to use a heat activated scrim or web as the adhesive material to bond the layers together. As a further alternative, it would also be possible to use a melt fusible strand component as one of the twisted monofilament strands. Suitable yarns of this type may be obtained, for example, under the trade name Grilon® from Swicofil A G of Emmenbruecke, Switzerland. Other similar materials may be suitable.

As a further alternative adhesive means to unite the components of the nonwoven textile assembly of this invention, the heat activated adhesive scrim 16 could be replaced by a pressure sensitive adhesive, such as 3M Spray 77™ available from 3M Corp. of St. Paul, Minn. or other similar suitable pressure sensitive adhesive in the form of a film or liquid. A spray adhesive is presently preferred as it does not interfere with physical properties of the fabric to the same extent that a liquid or film type of adhesive would. If a pressure activated adhesive is used, then it may not be necessary to provide a heated nip or heat the individual yarns. The nip may or may not be heated, depending on the characteristics of the adhesive (i.e. adhesive is heat or pressure activated) and the temperature of the heated MD strands or material as they come in contact with the adhesive scrim. However, one of the strand temperature or the nip pressure must be sufficient for the MD strands to bond to the adhesive scrim and the batt.

A fabric component 22 is connected to a first surface of the yarn array 12 using the adhesive 16. The fabric component 22 is comprised of one of: a nonwoven mesh; a second nonwoven array of parallel yarns; or another nonwoven material such as a scrim or web. If a nonwoven scrim or web is used, it preferably contains a regenerated cellulosic such as rayon as at least a portion of its component materials. The fabric component 22 may also be comprised of an array of generally parallel yarns having a desired spacing and characteristics which may be similar to that of array 12. If a second array of parallel yarns is used as component 22, then the parallel yarns of the component 22 must be oriented at an angle of from about 2° to about 90° to the yarns 14 of the yarn array 12. This required angular orientation helps to maintain the void volume of the base fabric, thus augmenting the dewatering capability of the press felt. If the yarns of a second array of yarns utilized as fabric component 22 are oriented so as to be parallel to the yarns 14 of array 12, then there is a danger that the yarns of the second array would, following application of pressure, become “nested” in between the yarns 14 of the array 12, thereby decreasing the void volume and caliper of the felt. Accordingly, this is not recommended.

Fabric component 22 may also be comprised of an extruded nonwoven mesh 24 as shown in FIGS. 1 and 3. A material that is presently preferred for this purpose is Conwed NL1300 available from Conwed Plastics of 2810 Weeks Ave. SE, Minneapolis, Minn. 55414. The fabric component 22 is preferably laid over the adhesive 16, which is preferably in the form of the heat activated adhesive scrim.

As a further alternative, the nonwoven mesh of component 22 may be replaced with a nonwoven rayon web or scrim material such as described by Despault et al. in US 2005/0136757. Optionally, it is possible to construct the nonwoven textile assemblies of this invention by omitting fabric component 22 altogether, leaving only yarn array 12, adhesive scrim 16 and batt layer 30. It is also possible to omit the adhesive scrim 16 if yarns containing a heat or pressure activated adhesive are used in the array 12.

Alternatively, the adhesive may be provided as a separate coating applied before or during construction of the nonwoven textile assembly 10.

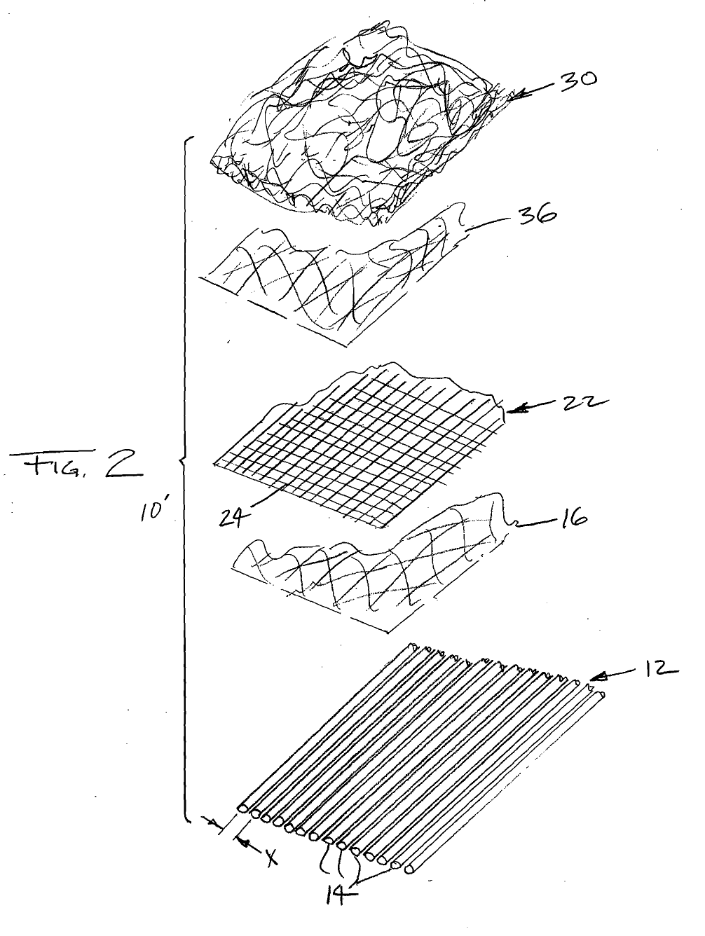

A layer of lightweight batt material 30 is preferably bonded to the fabric component 22. The batt material 30 can also include an adhesive or bi-component yarns, as shown in FIG. 1, and may be applied in conjunction with or instead of a second heat activated adhesive scrim 36, such as the types noted above and as provided in an alternate embodiment of the nonwoven textile assembly 10′ shown in FIG. 2.

One known material for the batt 30 that contains bi-component fibers with a low-melt adhesive is Cambrelle™ available from Camtex Fabrics Ltd., Blackwood Road, Lillyhall North, Workington, Cumbria Calif. 14 4JJ, United Kingdom.

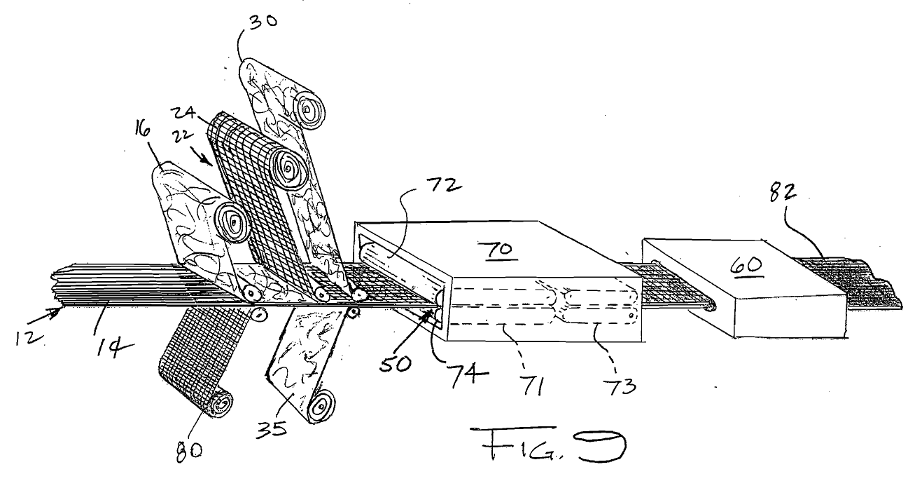

The assembly 10, 10′ formed of all the aforementioned components including yarn array 12, adhesive 16, optional fabric component 22, optional adhesive 36 and batt material 30, is passed through a heated nip 50 formed between two heated belts 72, 74 of a laminator 70, shown in FIG. 9, or pressure rolls 52, 54, such as shown in FIGS. 6 and 8. A belt laminator 70 is particularly suitable for this purpose and is presently preferred. A suitable laminator 70 for this purpose is a belt type laminator such as is available from Maschinenfabrik Herbert Meyer GmbH of Roetz, Germany. The heat from the heated nip 50, which can optionally be augmented through pre-heating the array of yarns 12 with an upstream pre-heater such as an infrared heat source, hot air source or the like (not shown, preferably located upstream of the yarn guide 40) activates the adhesives, adhesive scrim(s) 16, 36 and/or bi-component materials causing the yarns 14 in the array 12, mesh 24 and batt 30 components to become bonded together. Immediately following the heat activated bonding, the assembly 10, 10′ is preferably cooled by means of a separate cooling, for example by a second cooling area either in the belt laminator 70 or immediately following heated nip 50. This prevents the adhesives in the assembly 10, 10′ from sticking to the heated belts or rolls and discourages curling or other undesirable distortion of the assembly 10, 10′.

The nonwoven textile assembly 10, 10′ will be exposed to further processing, such as needling using a needling apparatus 60 (shown in FIGS. 8 and 9) or other known finishing processes generally known in the art of processing industrial papermaking textiles downstream of the heated nip 50.

Alternatively, a batt 30, 35 can be applied simultaneously to both sides of the yarn array and fabric component 12, 22. The batt 30, 35 preferably has a weight of less than about 100 gsm (grams per square meter) and preferably includes an adhesive scrim already bonded to the sides which will face the yarn array or extruded mesh. As the adhesive scrim comes in contact with the heated nonwoven mesh or yarn array, the adhesive is activated causing the batt to bond to the MD strands. Improved adhesion of the scrim can be obtained if one or both of the pressure elements forming the nip through which the array, scrim and batt pass is/are heated.

As a second alternative, a light weight batt 30, 35 is applied simultaneously to one or both sides of the yarn array 12 and fabric component 22. Just prior to entering the nip, a pressure sensitive adhesive is applied evenly over the side of batt which will come in contact with the array 12 and fabric component 22. The batt 30, 35, array 12 and the fabric components 22 pass together through the pressure nip and the batt 30, 35 is securely bonded to the strands.

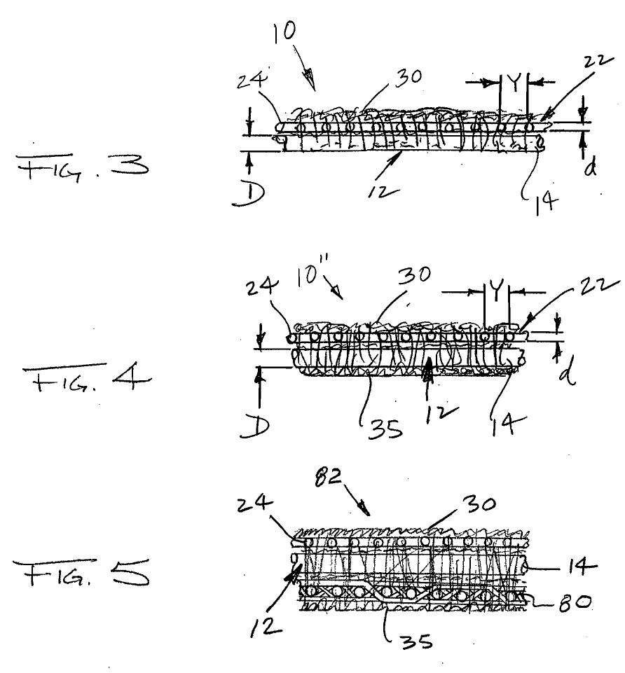

As shown in FIGS. 3 and 4, which show assembled nonwoven textile assemblies 10, 10″ according to the invention, the batt 30 can be applied to one side, as shown in FIG. 3, or batts 30, 35 can be applied to both sides, as shown for the assembly 10″ in FIG. 4. Preferably, the batts 30, 35 are needled to the nonwoven textile assemblies 10, 10′, 10″ in a known manner.

Still with reference to FIGS. 3 and 4, a void volume of the industrial textile assembly 10, 10′, 10″ can be tailored to particular applications based on a thickness or diameter D of the yarns 14, a thickness or diameter of d for the mesh 24 as well as a CD spacing X (shown in FIG. 2) between adjacent yarns 14 or a spacing Y between mesh elements of the mesh 24 within the fabric components 22, as well as the spacing between the elements of the array 12 and the fabric components 22. A diameter D of 0.65 mm for the yarns 14, which are preferably plied monofilament yarns with a CD spacing X of 0.65 mm (to provide a yarn fill of about 102% when 40 yarns per inch are used, or 15.75 yarns/cm) in the yarn array 12 combined with a mesh element thickness or diameter d of 0.56 mm and a mesh element spacing Y in the CD and MD of 20×20 yarns/in (or 7.87 yarns/cm) used with a single needled batt of 100 gsm provides an uncompressed void volume of approximately 65.5% (this is for the extruded mesh alone), which remains fairly constant in use, for example as a press fabric in a papermaking machine. The void volume can be easily and consistently adjusted by the present invention for particular applications since the MD spacing, size and number of the yarns 14 per unit CD width can be easily controlled or changed, and the yarns 14 are held in place by the adhesive 16 and stabilized by the mesh 24, which can also be specified in various configurations. Note that in this example it is the combination of the plied monofilament yarns 14 and the mesh 24 which provides virtually all of the void volume. If the warp fill of the yarn array 12 is reduced from 102% to, for example, 90% then the void volume would increase correspondingly. Similarly, if the mesh element spacing Y in the CD and MD of the mesh 24 is reduced from 20'20 to 15×15, for example, then the void volume will also increase correspondingly. However, it is critical that the yarn-to-yarn spacing X of the individual yarns 14 in the assembly 12 be maintained constant, and not vary by more than 75% of one of the individual plied yarn diameters, and more preferably the variance is less than 50% of the individual plied yarn diameter. Most preferably, the spacing varies by less than 25% of the individual plied yarn diameter. Further, the yarn position should not vary in a direction out of a plane of the yarn array by an amount greater than 75% of the diameter of an individual plied yarn. It is noted that for this example, the diameter D of 0.65 mm is the actual measured plied yarn diameter, and the calculated value would correspond to 0.727 mm from Table 1 (FIG. 16), with the variation being due to various factors such as compressibility of the material, elasticity, degree of twist, etc. The difference between the actual and the calculated values (0.49 mm vs. 0.55 mm) is 0.06 mm and is generally insignificant in the finished product.

Referring to FIG. 5, a nonwoven textile assembly 10, 10′ according to the invention can also be combined with and laminated to a woven base fabric 80 to form a textile assembly 82 having increased strength, stability and pressure uniformity for use in particular as a press felt in a papermaking machine. The batt 30 is applied to one side, and the second batt 35 is applied to the other side, after the base fabric 80 is positioned. Passing the stacked layers through a heated nip 50 attaches the layers to one another. Preferably, the batts 30, 35 are then needled to the textile assembly 80 in a known manner.

Method of Manufacture

Referring to FIG. 6, a method of manufacturing the nonwoven textile assembly 10 will be explained in more detail. The yarns 14 are preferably fed under controlled tension from yarn creels or canisters (not shown) and pass through a reed 38 and optional lease rods 37, 39 so that the yarns 14 are oriented in a generally parallel and uniformly spaced manner. Yarn tensions of between 2 and 10 pli provide acceptable results and help to ensure the planar, uniform spacing of the yarns, as well as prevent surface deformations in the finished assembly 10.

The yarns 14 then pass through a yarn guide box 40 for uniform alignment. A heat tunnel may be provided upstream of or incorporated with the yarn guide box 40 for heating the yarns to a generally uniform temperature sufficient for activating an adhesive, depending on the particular application. As shown in FIG. 7, a plied yarn 14 with four monofilaments passes through each of the respective individual channels 42 in the yarn guide box 40. Heating may not be necessary under conditions where sufficient heat is provided by the heated nip (such as when the belt laminator is used).

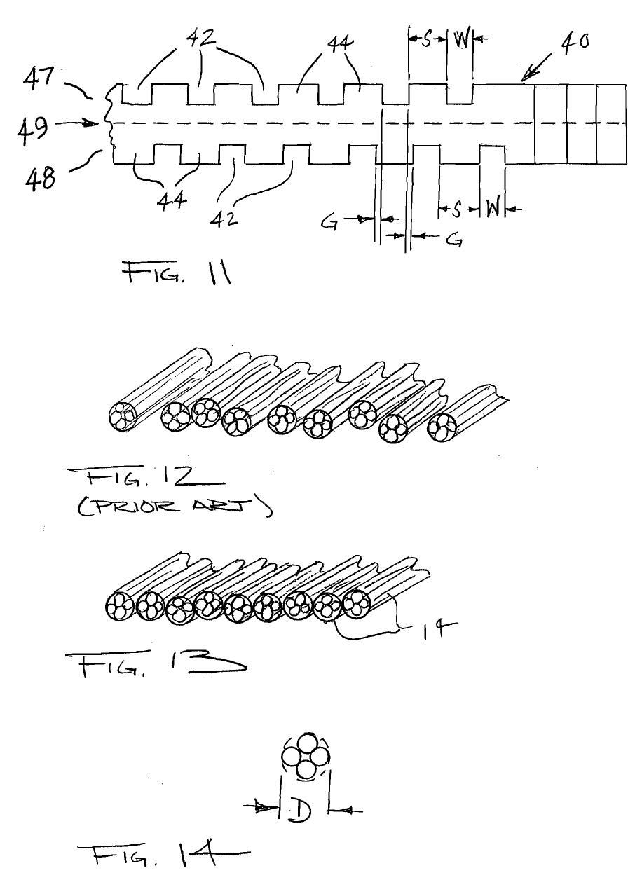

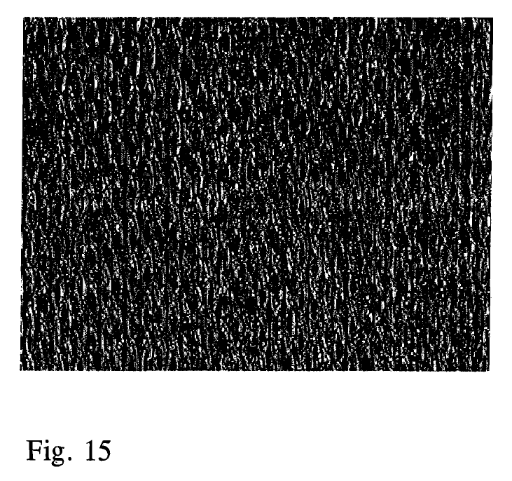

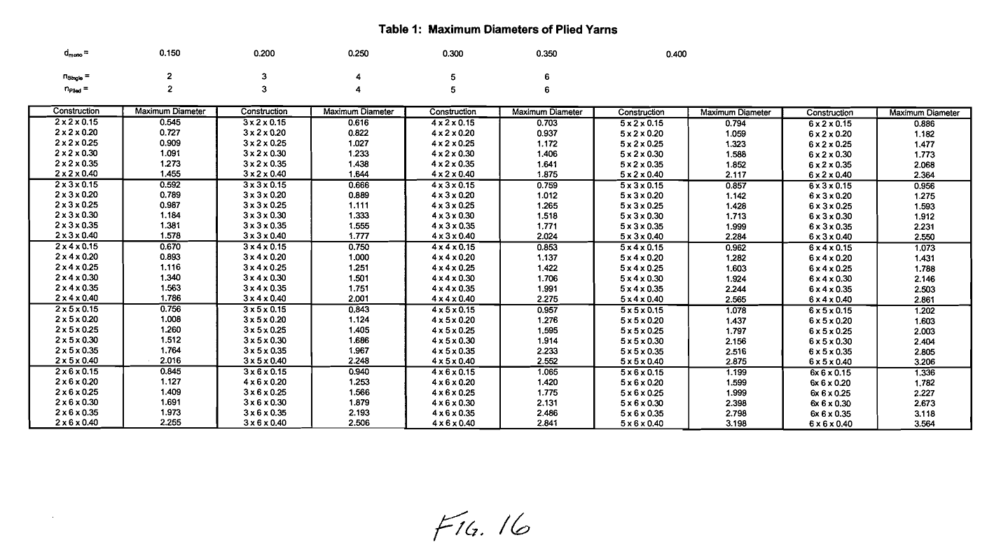

Referring to FIG. 11, the channels 42 in the yarn guide box 40 are positioned to ensure that the yarns 14 are consistently and uniformly spaced as they proceed to assembly downstream. The channels 42 are also arranged such that there is little or no space in the CD between adjacent channels 42, which are arranged over or under one another as each channel 42 is separated from the next adjacent in the row by a “tooth” 44. The individual channels 42 will have a width W that is from 10% to 35% less than the total width or diameter D of the yarns 14, shown in FIG. 14, when those yarns are plied monofilaments, or from 2% to 10% less than the total width or diameter of the yarns 14 when monofilaments are used. The width S of each tooth 44 can be less than, equal to, or slightly greater than the width W of the channels 42. In the illustrated example where the apparent spacing G between adjacent channels 42 is a positive number, it is preferably less than or equal to the difference between D and W so that approximately 100% fill is achieved, as illustrated in FIG. 13 and shown in FIG. 15. The spacing of the channels 42 in the upper portion 47 of the box 40 relative to the lower portion 48 can be adjusted by various means so as to alter the warp fill of the yarn array 12. One means for carrying this out is to split the box 40 into two halves 47 and 48 along line 49. The position of the channels 42 can then be adjusted by moving one half of the box, e.g. 47, relative to the other half 48. In this way, the yarn spacing can be changed quickly and easily to provide differing fill levels in the array 12.

In one preferred fabric produced in accordance with the teachings of the present invention, four 0.20/2/2 plied monofilament yarns, each having an average diameter of 0.65 mm, were passed through 2 mm wide channels 42 of a yarn guide box 40. In this case, the width of the channels 42 was thus 30% less than the total width of the yarns passing through them (4×0.65=2.60 mm). This caused the individual twists of the plied monofilament yarns to nest closely one against the other and to crowd each other without any vertical displacement. Upon exiting the channels 42 of box 40, the yarns 12 formed a uniformly planar and regularly spaced array of yarn 12 in which their spacing provided a 100% yarn fill in the array. The yarn-to-yarn spacing of the individual yarns 14 did not vary by more than 25% of one yarn diameter (i.e.: the yarn-to-yarn spacing from one yarn to the next did not vary by more than 0.18 to 0.16 mm). Surprisingly, the yarns 14 from each of the two rows fall into alignment beside one another and form a planar surface as they exit the yarn guide box being laid immediately adjacent and parallel to one another with no bending or other lateral movement. This ensures that the yarn array 12 is dimensionally uniform even at high yarn fill. The yarn to yarn spacing is constant and is most preferably at about 100% yarn fill so as to minimize any gaps or discontinuities in support. This is essential to providing a base fabric which does not mark the sheet and which is dimensionally rugged. This was a surprising result that was not anticipated using the arrangement described.

The uniform spacing of the yarns 14 in the CD is also clearly shown in FIGS. 13 and 15, and is made possible by the arrangement according to the present invention. It has now been discovered that an arrangement such as provided by yarn guide box 40 guides the yarns such that they form a flat uniform surface with constant yarn to yarn spacing which does not vary by more than 75% of one yarn diameter, either in the CD of the array, or out of the plane of the array and is usually much less at about 25% of one yarn diameter. In contrast, prior to the present invention, it was thought that a reed such as 38 was sufficient to ensure the constant yarn spacing and planarity necessary to provide a non-marking fabric. In the known prior art devices, non-uniform CD spacing of the yarns helps to create the non-uniformity that results in shadow marking of the paper sheet when the fabric is used as a press felt in a papermaking machine. The present invention provides a solution to this problem.

The channels 42 of yarn guide box 40 may also be heated along their MD length so that the yarns 14 are uniformly heated prior to reaching the nip.

The yarns 14 are preferably drawn with a uniform, low tension of about 2 pli to 10 pli, through the lease bars 37, 39 to ensure uniformity across the fabric strip. The low tension prevents excess tensile strain on the yarns that can result in crinkling or crimping of the fabric surface after the array is bonded in position due to the tension then relaxing. The fact that the lease bars 37, 39 create a uniform tension from yarn to yarn across the array also helps to prevent such surface deformations.

An adhesive, preferably in the form of the heat activated adhesive scrim 16, is applied onto the yarns 14 after they pass through the yarn guide box 40.

The fabric component 22 in the form of a mesh 24 is then placed onto the yarn array 12. Optionally, a second yarn array 64, for example as indicated in FIG. 8, is directed from a second supply arrangement 62 so that the yarns of the array 64 are canted at an angle of from 2° to 90° to the yarns 14 of the array 12. The second yarn array 64 can be provided by a variety of means; one of which is that described by Colson et al. in U.S. Pat. No. 7,056,403, which is incorporated by reference herein as if fully set forth. As a further option, the fabric component 22 may be a loosely woven or nonwoven scrim of a regenerated cellulosic or rayon such as described by Despault et al. in US 2005/0136757. Selection of an appropriate fabric component 22 will be dictated by the end use requirements of the assembled fabric. A batt 30, optionally comprised of bi-component yarns, is then placed on the fabric component 22.

The stacked yarn array 12, fabric component 22 and batt 30 are then passed through a nip 50 in a belt laminator 70 or between two pressure rolls 52, 54 to activate the adhesive, bonding the textile components together to form the nonwoven textile assembly 10. A belt laminator is preferred for the assembly of the various components of the nonwoven textile assembly of the present invention. If pressure rolls such as rolls 52, 54 are used, they are preferably heated to ensure complete activation of the adhesive. However, this is not required. In either case, it is recommended that a cooling zone be located downstream of the heated nip. The cooling zone helps prevent distortion of the nonwoven fabric assembly, as well as preventing the adhesives from sticking to the rolls or belt. This can be provided by a belt laminator 70, as shown in FIG. 9 having a separate heating zone 71 and cooling zone 73.

While the array of parallel yarns 12 is disclosed as being located at or near one of the planar surfaces of base fabric 80 and fabric component 22 is disclosed as a mesh 24 located inside the fabric structure, the positions of these components can be reversed, or as previously described the mesh 24 can be replaced by a second array of yarns which may be oriented at an angle to the first array 12. The arrays would then be held together by the adhesive 16 to form the nonwoven textile assembly 10. It is preferred that the MD array 12 is located closest to the surface of the base fabric that will be in contact with the paper sheet.

Further processing of the textile assembly 10 is possible, such as needling or other finishing.

Referring to FIG. 8, a similar arrangement to FIG. 6 is shown, further including a needling apparatus 60 located downstream of the pressure rolls 52, 54. The belt laminator 70 or pressure rolls 52, 54 are heated if a heat activated adhesive is to be utilized. Alternatively, no heat is required for a pressure activated adhesive. A second batt 35 is shown being applied beneath the yarn array 12 so that the nonwoven textile assembly 10″ is shown being produced.

Referring to FIG. 9, a similar arrangement to FIG. 8 is shown with a belt laminator 70 as discussed above being used in place of the pressure rolls 52, 54. Additionally, a woven base fabric 80 may be assembled with the nonwoven textile assembly in order to form the near finished textile 82 which is particularly suitable for use in the construction of press felts.

Method of Forming a Press Felt

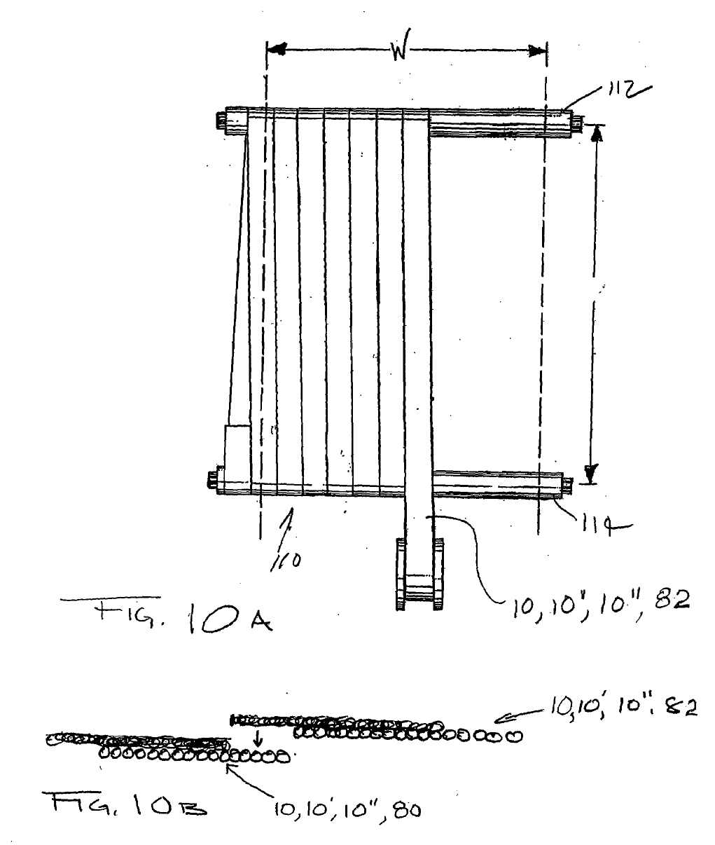

Referring to FIGS. 10A and 10B, a method of forming a press felt 110 according to the invention is provided by spirally winding sufficient turns of the nonwoven textile assembly 10, 10′, 10″ or the textile assembly 82 between two rolls 112, 114 to build up the desired width W of base fabric. This can be done in a known manner, for example as provided by U.S. Pat. No. 6,565,713, which is incorporated herein by reference as if fully set forth. Adjacent edges of the spirally wound strip may also be joined together by sewing (as is well known in the art) and although a lap joint as shown in 10B is recommended to ensure the strip to strip spacing, the strips may also be butt joined in a manner also known in the art. The fabric 110 is then trimmed to size. The array of yarns 12 in the nonwoven textile assembly extend generally in the MD of the fabric providing good tensile strength and elongation resistance as well as an easily pre-definable void volume for the fabric 110.

Fabric assembly may of course be accomplished by other means. In one alternative, the nonwoven textile assembly 10, 10′, 10″ is spirally wound onto one of a woven fabric or needled batt which has been slipped over the rolls 112, 114 and is the complete length of the desired finished product. The fabric or batt may be previously spirally constructed and assembled to the full length and width of the desired finished product. Alternatively, it may be woven or needled to provide the full length and width of the finished product. The assembly 10, 10′, 10″ is then wound over this fabric and attached thereto by heat (bonding), a light needling process by a moveable carriage means (not shown) or other suitable method.

Those skilled in the art will recognize that the present invention provides a press felt of spiral wound construction having MD yarns that are uniformly spaced in the CD at high yarn fill and located in a single plane with little or no vertical displacement. This results in a high strength, dimensionally stable fabric which provides low sheet marking and excellent fabric performance. While the present invention has been described in terms of the preferred embodiments with a parallel yarn array and a fabric component layer, more layers could also be added, and those skilled in the art will recognize that various modifications can be made within the scope of the present invention.

1. A nonwoven textile assembly, comprising:
a first fabric component comprising generally parallel extending yarns arranged at constant spacing and at a uniform height which does not vary by more than 75% of an average width of a yarn joined together by at least one of heat or an adhesive to provide an array having a yarn fill of from 60% to 105%;
a second fabric component connected to a first surface of the first fabric component using at least one of an adhesive or heat fusion through the application of at least one of heat or pressure; and
at least one layer of batt material connected to one surface of the first or second fabric components by at least one of an adhesive, heat fusion or needling.

2. The nonwoven textile assembly of claim 1, wherein the first fabric component is located on a side of the second fabric component facing a paper support side of the nonwoven textile assembly.

3. The nonwoven textile assembly of claim 1, further comprising an adhesive layer located between first and second fabric components.

4. The nonwoven textile assembly of claim 3, wherein the adhesive layer comprises an adhesive scrim.

5. The nonwoven textile assembly of claim 1, wherein an adhesive is provided on or in at least one of the first or second textile components.

6. The nonwoven textile assembly of claim 1, wherein the batt is joined to the first or second fabric components by an adhesive.

7. The nonwoven textile assembly of claim 1, wherein the batt is joined to the fabric components by needling.

8. The nonwoven textile assembly of claim 1, wherein the batt includes bi component fibers, and is joined to the first or second fabric components by heat activation of a lower melting point component of the bi component fibers.

9. The nonwoven textile assembly of claim 1, wherein the first fabric component comprises monofilaments, plied monofilaments or multifilaments.

10. The nonwoven textile assembly of claim 1, wherein the second fabric component comprises generally parallel extending yarns joined together by at least one of heat or an adhesive.

11. The nonwoven textile assembly of claim 10, wherein the second fabric component has a yarn fill of 60% to 105%.

12. The nonwoven textile assembly of claim 10, wherein the second fabric component has a yarn fill approximately equal to a yarn fill of the first fabric component.

13. The nonwoven textile assembly of claim 10, wherein a yarn to yarn spacing of the second fabric component does not vary by more than 75% of an average width of a yarn.

14. The nonwoven textile assembly of claim 1, wherein the second fabric component comprises a nonwoven mesh.

15. The nonwoven textile assembly of claim 14, wherein the nonwoven mesh is an extruded mesh material.

16. The nonwoven textile assembly of claim 1, wherein the second fabric component comprises a nonwoven scrim of a regenerated cellulosic.

17. The nonwoven textile assembly of claim 16, wherein the regenerated cellulosic is rayon.

18. The nonwoven textile assembly of claim 1, wherein a void volume of the textile assembly is adjustable by a varying a thickness of yarns or a mesh used to form the first and second fabric components and a spacing between adjacent yarns or mesh elements within the respective first and second fabric components and between the first and second fabric components.

19. A textile assembly, comprising the nonwoven textile assembly of claim 1 either attached to or assembled with one of a woven base fabric or a needled cohesive batt material.

20. The nonwoven textile assembly of claim 1, wherein the yarn fill is between 90% and 105%.

21. The nonwoven textile assembly of claim 1, wherein the assembly comprises a component of a spirally wound press felt.

22. A method of forming a nonwoven textile assembly comprising generally parallel extending yarns arranged at constant spacing and at a uniform height joined together by at least one of heat or an adhesive to provide an array having a yarn fill of from 60% to 105%, comprising:
a. passing an array of yarns through a yarn guide device to provide at least a first fabric component,
b. stacking a second fabric component onto a first fabric component;
c. passing the stacked first and second fabric components through a nip between opposing pressure applying devices,
d. bonding the first and second fabric components together to form a laminated substrate, at least one of the first and second fabric components consisting of an array of parallel yarns.

23. The method of claim 22, further comprising:
providing a first fabric component as the array of parallel yarns;
applying an adhesive to the first fabric component; and
heating the parallel yarns prior to or during passing the stacked components between the opposing pressure applying devices.

24. The method of claim 22, further comprising the second nonwoven textile comprising a second layer of yarns over the adhesive.

25. The method of claim 24, wherein the second layer of yarns are oriented at an angle of from 2° to 90° to the yarns of the first fabric component.

26. The method of claim 22, wherein the yarns of the second fabric component are arranged at a yarn fill of from 60% to 105%.

27. The method of claim 22, wherein the second fabric component is a nonwoven scrim of a regenerated cellulosic.

28. The method of claim 22, wherein the adhesive is a nonwoven adhesive scrim.

29. The method of claim 22, wherein the adhesive is heat activated or pressure sensitive.

30. The method of claim 22, further comprising:
applying a nonwoven batt to at least one side of the laminated substrate.

31. The method of claim 30, further comprising:
needling the batt to the laminated substrate.

32. The method of claim 22, further comprising:
attaching the nonwoven textile assembly to one of a woven base fabric or a previously prepared and needled cohesive batt material.

33. The method of claim 22, further comprising:
aligning the array of yarns in the yarn guide device to provide a yarn-to-yarn spacing and uniform height which does not vary by more than 75% of an average width of a component yarn.

34. The method of claim 33, wherein the yarn guide device includes at least an upper set of channels for receiving a portion of the array of yarns and a lower set of channels for receiving a different portion of the array of yarns, and individual channels of the upper set of channels are located in positions between channels of the lower set of channels.
